(19) United States
(12) Patent Application Publication
(10) Pub. No.: US 2024/0223675 A1
(43) Pub. Date: Jul. 4, 2024

(54) TRAFFIC MANAGEMENT IN EDGE CACHING

(71) Applicant: International Business Machines Corporation, Armonk, NY (US)

(72) Inventors: Gandhi Sivakumar, Bentleigh (AU); Kushal S. Patel, Pune (IN); Sarvesh S. Patel, Pune (IN)

(21) Appl. No.: 18/147,751

(22) Filed: Dec. 29, 2022

(51) Int. Cl. H04L 67/5682

(52) U.S. Cl. CPC H04L 67/5682

(57) ABSTRACT

Embodiments relate improved traffic management in edge caching. Responsive to an emergency trigger, an edge device receives a map from a target system, the edge device including a cache having a plurality of blocks, where the map is representative of content in a data volume of the target system. The edge device determines at least one block of the plurality of blocks in the cache different from the content in the data volume based on the map. The edge device sends the at least one block in the cache to the target system, responsive to the emergency trigger.

### BACKGROUND

The present invention generally relates to computer systems, and more specifically, to computer-implemented methods, computer systems, and computer program products configured and arranged to provide improved traffic management in edge caching.

Traditional networks had a centralized approach to managing data. Information is collected on the outer edges of the network, where it encounters end users and Internet of things (IOT) devices. That data is then transferred back to the servers in the network core for processing so that instructions or other responses can be sent back to the devices and users on the edge. An issue with this arrangement is that it introduces latency delays while data travels back and forth. Edge computing upends the traditional architecture by shifting key processing functions away from the core of the network and out to the edge where users are located. Through a combination of edge data centers and IoT devices that can process data for themselves, edge computing can improve network performance and reduce latency. While there are benefits from relocating processing functions closer to where they are actually needed, the network also benefits from a bandwidth perspective since the overall data traffic flowing to and from the network core is reduced. Since devices can still process data locally or through a nearby edge data center, edge computing networks are more resilient. They have the flexibility to gather and process data in multiple locations should any part of the network become inoperable.

### SUMMARY

Embodiments of the present invention are directed to computer-implemented methods for improving traffic management in edge caching, especially during an emergency. A non-limiting computer-implemented method includes responsive to an emergency trigger, receiving, by an edge device, a map from a target system, the edge device including a cache having a plurality of blocks, where the map is representative of content in a data volume of the target system. The method includes determining, by the edge device, at least one block of the plurality of blocks in the cache different from the content in the data volume based on the map. The method includes sending, by the edge device, the at least one block in the cache to the target system, responsive to the emergency trigger.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment illustrating further details for providing improved traffic management during an emergency destage of data in an edge device to a target device/system according to one or more embodiments of the present invention;

FIGS. 3A and 3B depict an example operational flow for improved traffic management during an emergency destage of data in an edge device to a target device/system according to one or more embodiments of the present invention; and

FIG. 4 is a flowchart of a computer-implemented method for providing improved traffic management during an emergency destage of data in an edge device to a target device/system according to one or more embodiments of the present invention.

### DETAILED DESCRIPTION

One or more embodiments of the invention describe computer-implemented methods, computer systems, and computer program products configured and arranged to improved traffic management in edge caching at an edge device. One or more embodiments improve the edge device caching mechanism during an emergency destage of the data, for example, during a power outage when limited backup power is available. This may be accomplished by performing the identification of deduplication fingerprints at the edge device level, by identifying data blocks/chunks that are saved in the cache of the edge device but not saved at the target device (e.g., the cloud). Accordingly, the edge device selectively sends the packets of data chunks, which are not saved at the target device, from the edge device to the target device at the cloud in order to avoid any unnecessary data transfer to the target device. This saves battery power of the edge device when emergency destage is triggered because of the power outage or any other emergency such as an imminent weather event (e.g., storm), natural disaster, etc.

Caching has long been the mechanism for storing temporary data or files for quick retrieval by users. With digital resources growing in demand globally from urban centers to disparate locations, edge computing leads the way in connecting developers and service providers with web clients closer to the web client's location. Edge caching is the integration of traditional caching methods and mechanisms into the edge computing infrastructure. By moving memory storage closer to end users, edge caching reduces stress on extensive networks and improves content delivery. Caching is the process of storing data for later access via software or hardware memory components. By keeping resources closer to the end user, edge caching mitigates traffic when users access the same resource regularly.

Some definitions are described below.

Destage. Destage is to asynchronously write new or updated data from a cache or nonvolatile storage to a direct access storage device.

Data deduplication. Data deduplication is a technique for eliminating duplicate copies of repeating data. The deduplication process requires comparison of data “chunks” (also known as “byte patterns”) which are unique, contiguous blocks of data. These chunks are identified and stored during a process of analysis and compared to other chunks within existing data. Whenever a match occurs, the redundant chunk is replaced with a small reference that points to the stored chunk. Given that the same byte pattern may occur dozens, hundreds, or even thousands of times (the match frequency is dependent on the chunk size), the amount of data that is stored or transferred can be greatly reduced.

The data in edge devices may contain hundreds, thousands, and/or millions of blocks of data, all of which is referred to as “big data”. In accordance with one or more embodiments, the enormous size of the data requires management, processing, and search by a machine (such as computer 101), for example, using computer-executable instructions, and the data could not be practically managed, stored, analyzed, and/or processed as discussed herein within the human mind. Embodiments can process the data and transfer data from one computer to another computer (or storage device) during an emergency to avoid data loss, data corruption, etc., while reducing bandwidth across the network according to aspects discussed herein. Accordingly, the data transfer can implement known techniques as understood by one of ordinary skill in the art. One or more embodiments improve the operations of computers and networks that connect computers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as traffic management code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

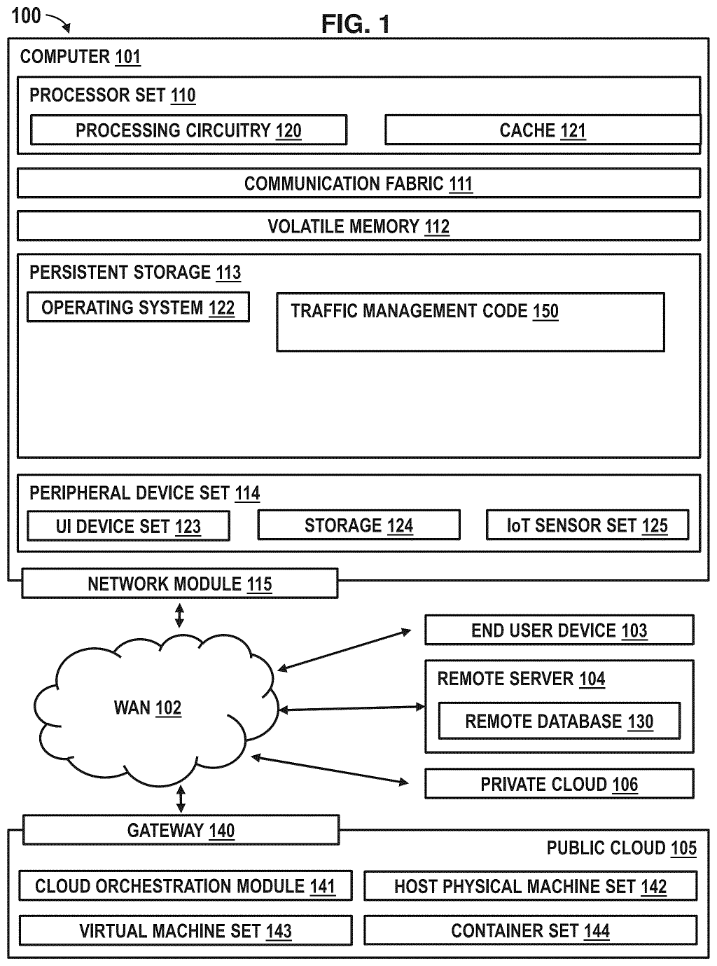

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

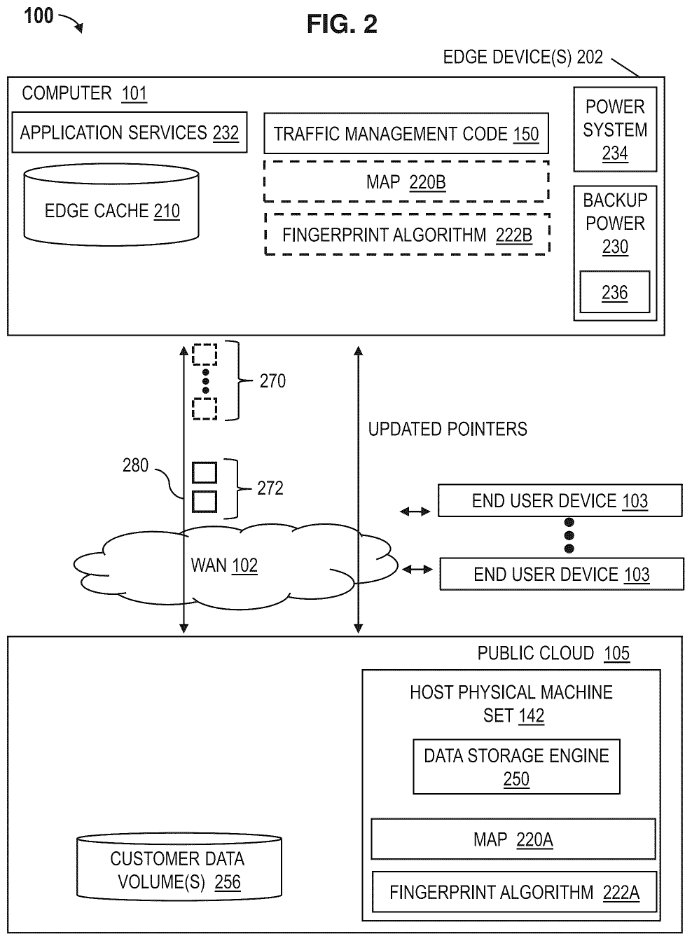

FIG. 2 depicts the computing environment 100 with further details for providing improved traffic management during an emergency destage of data in an edge device to a target device/system (i.e., the public cloud) according to one or more embodiments. In FIG. 2, some details of the computing environment 100 may be omitted so as not to obscure the figure while new details are presented. FIG. 2 illustrates numerous end user devices 103 connected to the WAN 102. In some cases, the end user devices 130 may be operatively connected to one or more edge devices 202 for application services 232, and the application services 232 of the edge device 202 are closer and faster than the connecting to the public cloud 105 for application services. The edge device 202 can include any of the functionality of the computer 101 including hardware and software. Similarly, any computer in the public cloud 105 including the host physical machine set 142 can be implemented to include any of the functionality of the computer 101 including hardware and software. The edge device 202 can communicate with the public cloud 105 to support the application services 232 for the end user devices 103.

The edge device 202 can perform edge caching in the edge cache 210 for the end user devices 103 that are directly communicating with an edge computing instance of the edge device 202 to store the generated data where most of the processing is performed at the edge device level. In such cases, the cloud storage instances in the public cloud 105 are paired with the edge device 202 to save the processed output which can be used for a further set of activities. One of the common examples could be the edge device 202 running some application (e.g., one or more application services 232) that is using the cloud data storage space to save the information. The cloud data storage space may include a customer data volume 256 for storing data. The customer data volume 256 can be representative of any type of suitable storage device. In such cases, all the processing is performed at the edge device 202, and the public cloud 105 is only leveraged to store the information (e.g., READ/WRITE). In such cases, the storage instance running in the public cloud 105 is directly paired with the edge device 202 to perform read and write operations. These instances offer the methods to connect the edge device 202 via a networking protocol, such as, for example, Internet Small Computer Systems Interface (ISCSI), Transmission Control Protocol/Internet Protocol (TCP/IP), to the public cloud 105, such that the edge device 202 can directly make use of the available storage space (e.g., in the customer data volume 256) in the public cloud 105. As such, the caching is maintained at the edge device level to avoid frequent data transfers to/from the public cloud 105 and to increase the performance benefits.

The edge device 202 is coupled to a main power system 234 that supplies power to the edge device 202. A backup power system 230 is configured to supply backup power in the event that the main power system 234 stops functioning, such as during a power outage. The backup power system 230 may be an uninterruptible power supply having one or more backup batteries to supply power to the edge device 202 during the power outage. A power module 236 or any suitable software and/or hardware component is configured to notify the traffic management code 150 that there is an emergency power failure and backup power system 230 has been activated to supply power. The notification acts as a trigger to the traffic management code 150 begin emergency destage operations for the cache 210 according to one or more embodiments discussed herein. The power module 236 can include and/or be coupled to one or more sensors (not shown) that detect the power outage of the main power system 234 and the supply power from the backup power system 230 as understood by one of ordinary skill in the art.

Upon detection of the external power outage of the main power system 234, battery power is supplied to the edge cache 210 in the edge device 202, so that the edge cache 210 can flush the data to a non-volatile disk storage, such as the customer data volume 256, in the public cloud 105. Once the external outage is detected, the edge cache 210 is destaged to the persistent storage space of the customer data volume 256 allocated in the public cloud 105, and then an edge device power off operation is performed by the edge device 202. This emergency destage is a special case which has to be handled with less power due to the limited battery power available in the backup power system 230. For example, there can be a situation in which there is a faulty/malfunctioning battery, and accordingly, the destage operation becomes even more critical and optimization is required in this area; accordingly, one or more embodiments provide an emergency destage operation that consumes less energy and provides better quality and assurance for the transfer of data from the cache to the public cloud.

In the state-of-the-art, the edge device's write cache is dependent on how much data can be destaged to the cloud location in the event of a power outage at the edge device. When the external power supply is not available to the edge device, the edge device is limited by the amount of data that can be transferred from the write cache to whatever the cache can flush to the storage location at the cloud with the limited battery backup power. When the external power failure is identified, it is important to destage the write cache to persistent storage in the cloud using an efficient technique because any delays might cause data corruption between the local location at the edge device and remote data location of the cloud.

According to one or more embodiments, the traffic management code 150 is configured to execute an edge device caching mechanism to improve the efficiency of the emergency destage of the data in the edge cache 210 by identifying deduplication fingerprints at the edge device level and selectively sending unique packets of blocks/chunks to the target location of the customer data volume 256 in order to avoid the unnecessary data transfer all blocks in the edge cache 210 to the customer data volume 256 (i.e., the target device). This saves battery power of the backup power system 230 by only transferring unique data blocks and not attempting to transfer all the data blocks of the edge cache 210, when the emergency destage is triggered. It is noted that the target, target device/system, target location, etc., refer to location of the persistent storage device, for example, the customer data volume 256, in the public could 105 for storing data.

When the traffic management code 150 of the edge device 202 is communicating with a data storage engine 250 of the public cloud 105 and issuing operations (e.g., READ/WRITE operations) on the customer data volume 256 (which can be issued via a data receiver (e.g., IBM Spectrum Virtualize™ for public cloud (SVPC) in the gateway 140), the data storage engine 250 offers many data optimization features, such as, for example, data deduplication and others. When the deduplicated space of the customer data volume 256 is allocated to the edge device 202, using the edge cache 210 saves the storage virtualization cost for the applications of end user devices 103 issuing a workload because the data can be cached at the edge cache 210. When the edge device 202 detects the external power failure, the traffic management code 150 triggers an emergency write cache flush to the allocated space to save the data before the edge device runs out of power. When the data storage engine 250 is running additional deduplication on the incoming data, on every incoming data request, the data storage engine 250 calculates the fingerprints of the incoming data using a fingerprint algorithm 222A, checks for a match to the fingerprints of the available track records in a map 220A, and decides to execute the actual write to the disk of the customer data volume 256 based on whether the fingerprints of the incoming data blocks match the stored fingerprints in the map 220A. If there is a match between the fingerprints, the incoming data is not saved because the data blocks are already present in the customer data volume 256. When the fingerprints do not match, the data storage engine 250 is configured to execute the disk write operations, and the edge device 202 (initiator) is notified at the completion (soft completion). Since all these operations are executed at the target level (i.e., at the public cloud 105), the initiator system (i.e., edge device 202) has no understanding of this and keeps sending the workload (e.g., for WRITE operation) during the process. According to one or more embodiments, this deduplication process is extended to the edge device 202. For example, during emergency destage, the traffic management code 150 is configured to perform the deduplication fingerprint matching at the edge device 202 using in-band or out-of-band protocols to ensure that the edge device 202 does not send data to the public cloud 105 when the fingerprints match but only sends pointer updates.

An example scenario is discussed. The data storage engine 250 running in a host physical machines in the host physical machine set 142 in the public cloud 105 identifies the deduplication state for the customer data volumes 256 utilized for the edge device 202 and activates the edge metadata transfer logic for the customer data volumes 256 that are dedicated to the edge device 202. The deduplication fingerprints of the customer data volumes 256 are stored in a map 220A along with other identifying information. Using the data storage engine 250, host connection mapping is also maintained to dynamically enable/disable application programming interface (API) doors by APIs for the exchange of emergency destage metadata. When the traffic management code 150 detects the emergency destage, the traffic management code 150 sends a message (e.g., SIGNAL) to the data storage engine 250 to initiate and/or prepare for emergency destage. This can be performed using an in-band or out-of-band API interface to inform the public cloud 105 (target) that emergency destage is triggered at the edge device 202 (initiator side).

When the public cloud 105 receives the message (e.g., SIGNAL), the data storage engine 250 locates an initiator entry and the map 220A of the entries with the volumes mapped to the edge device 202. The data storage engine 250 inquires of the deduplication status for the customer data volumes 256. When deduplication is enabled for the customer data volumes, data storage engine 250 opens the communication tunnel 280 to validate the deduplication fingerprints for the customer data volume 256. After this, the traffic management code 150 (i.e., initiator) is notified by the data storage engine 250 to validate the fingerprints for the blocks in the edge cache 210 that need to be destaged (i.e., transferred or written) to the customer data volumes 256 of the public cloud 105. Accordingly, the data storage engine 250 sends the fingerprint calculator algorithm 222A and the associated map 220A to the edge device 202 over the communication tunnel 280. The received fingerprint calculator algorithm 222A is stored as fingerprint calculator algorithm 222B and the received map 220A is stored as map 220B in the edge device 202. The traffic management code 150 uses the fingerprint calculator algorithm 222B to calculate the deduplication fingerprints for all the participating blocks in the edge cache 210. As an example, the fingerprint calculator algorithm 222A, 222B may be a hash operation, and each fingerprint can be hash of a predetermined number of blocks. The fingerprints calculated for the blocks in the edge cache 210 at the edge device 202 are compared to stored fingerprints in the map 220B (e.g., a B-tree) for the blocks stored in the customer data volume 256. Upon comparing the blocks of data, the traffic management code 150 sends a bitmap of the blocks (e.g., an array of block bitmaps and their volume logical block addresses/addressing (LBAs)) that are not stored in the customer data volume 256. For the blocks that are found in the map 220B (e.g., B-tree) because the calculated fingerprints match the stored fingerprints in the map 220B, the traffic management code 150 sends updated tree pointers for logical block addresses/addressing (LBAs). Upon receipt of the updated tree pointers from the edge device 202, the data storage engine 250 updates the tree pointers for the defined logical block LBAs associated with the blocks in the customer data volume 256 and sends a message (e.g., WRITE complete message) to the edge device 202. For the fingerprints of blocks of the edge cache 210 that are not found in the map 220B (e.g., B-tree), the traffic management code 150 locates the blocks in the local edge cache 210, sends the located blocks of data (as example blocks of data 272) over the communication tunnel 280 to the public cloud 105, and waits for a completion response. The remaining blocks of data 270, shown as dashed lines, in the edge cache 210 are not required to be sent over the communication tunnel 280 during the emergency destage, thereby avoiding a situation where the blocks of data 270 that already having matching fingerprints to the prestored fingerprints in the map 220B are sent while the (needed) blocks of data 272 are not sent because of battery failure.

Because the data storage engine 250 already knows that the blocks of data 272 are for new fingerprints, the data storage engine 250 bypasses the fingerprint calculation (of fingerprint calculation algorithm 222A) on the incoming I/O requests for the new blocks of data 272, saves (WRITES) the blocks of data 272 to a new location in the customer data volume 256, and sends an acknowledgement (ACK) to the edge device 202. The traffic management code 150 and the data storage engine 250 can each include, be integrated with, call, and/or function with various software applications, protocols, APIs, etc., as understood by one of ordinary skill in the art, in order to perform methods of one or more embodiments.

There are many technical benefits and technical solutions according to one or more embodiments. As one aspect, this avoids a cache destage overrun in which the cache might lose content at the edge device resulting in data loss. One or more embodiments provide faster data transmission during the emergency, because less data needs to be transferred over the network (i.e., only blocks of data 272 are transferred while additional blocks of data 270 are not transferred), thereby making the transfer faster. One or more embodiments provide better resource utilization and network performance over the network, because at the time of the emergency cache destage, other processes are halted since this is considered the most important task for the edge device before it shuts down. Accordingly, computer resources are free to be utilized for a faster cache destage completion.

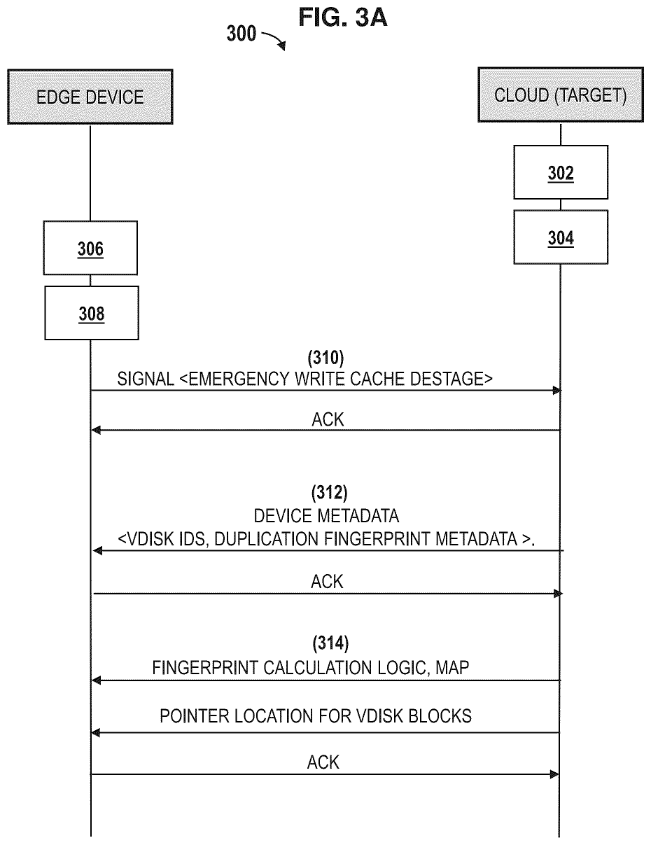

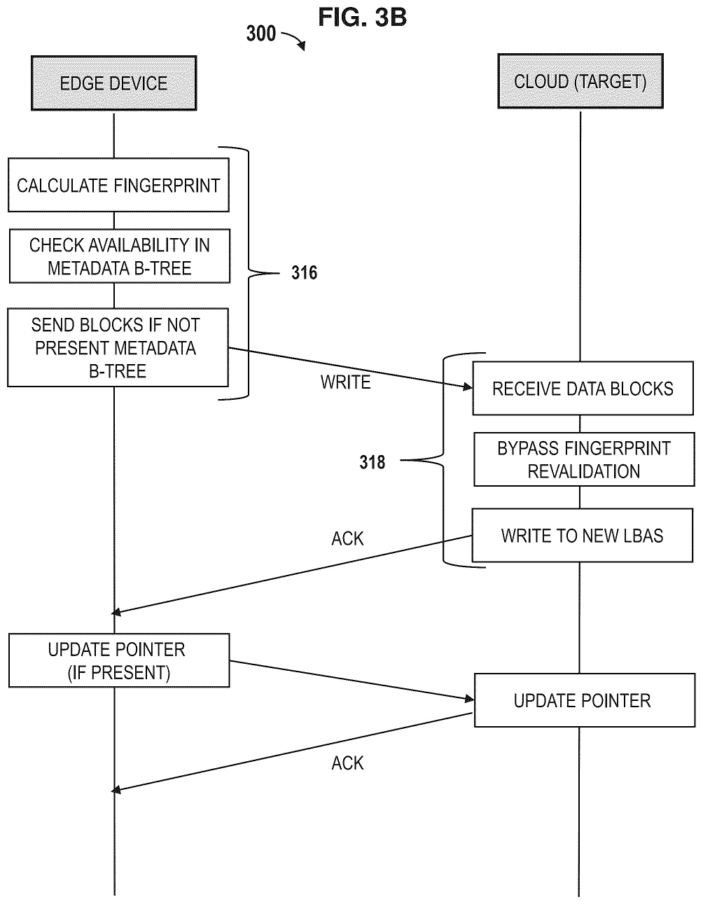

FIGS. 3A and 3B depict an example operational flow 300 for improved traffic management during an emergency destage of data in an edge device to a target device/system (i.e., the public cloud) according to one or more embodiments.

Referring to FIG. 3A, at block 302, the data storage engine 250 is initialized to handle data requests (e.g., READ/WRITE requests) from edge devices via internet based network protocols such as TCP/IP, ISCSI, iWARP, remote direct memory access (RMDA) over convergenced ethernet (RoCE), etc. The data storage engine 250 collects the information about the customer data volumes 256 mapped to the edge devices 202, including their capacity and provisioning details. This information is classified into read and write data issued by the application (e.g., of application services 232) in recent cycles on the customer data volumes 256. The reconstruction capabilities are defined based on the write orientation of the data.

At block 304, when deduplicated space in the customer data volume 256 is allocated/assigned to the edge device 202, the data storage engine 250 updates the metadata map 220A of the customer data volume 256 corresponding to the edge cache 210 of the edge device 202 including the device entity such as the unique iSCSI qualified name (IQN) and/or the NVMe qualified name (NQN) for the edge device 202. Also, the lists of Universally Unique IDentifiers (UUIDs) for edge devices are updated to indicate that the edge devices are for deduplication optimization.

At block 306, the traffic management code 150 (e.g., including a service client) is initiated in the edge device 202 in conjunction with a battery backed write cache processor. This is to be used to execute the deduplication fingerprint matching at the edge device 202 using in-band or out-of-band protocols. The communication protocol is to be initiated to make the communication tunnel 280 between the traffic management code 150 and the data storage engine 250. The authorization (AUTH) policies are exchanged, and the secured communication tunnel 280 is created between the edge device 202 and the public cloud 105.

At block 308, the data storage engine 250 identifies the deduplication state for the customer data volumes 256 assigned to the edge devices 202. The data storage engine 250 further activates the edge metadata transfer logic for the customer data volumes 256 for which the dedication is enabled. In metadata mapper tables of the map 220A, the host connection mapping is configured to dynamically enable/disable the API doors for exchanging the emergency destage metadata.

At block 310, in response to detecting the emergency destage (for example, because of a power failure to the main power system 234), the traffic management code 150 of the edge device 202 sends a message (e.g., SIGNAL) to the data storage engine 250 of the public cloud 105 to start procedures for emergency destage. This can be performed using an in-band or out-of-band API interface to inform the public cloud 105 that the emergency destage is triggered at the edge device 202. The data storage engine 250 acknowledges (ACK) receipt of the message (e.g., SIGNAL).

At block 312, in response to the data storage engine 250 receiving the message (e.g., SIGNAL), the data storage engine 250 locates the initiator entry and map 220A having the entries with the customer data volumes 256 mapped to the edge device 202 (e.g., UUID to IQN map). The data storage engine 250 checks the map 220A for and obtains the deduplication status for the customer data volumes 256 assigned to the edge cache 210 of the edge device 202. When deduplication is enabled for the customer data volumes 256, the data storage engine 250 opens the communication tunnel 208 with the edge device 202 in preparation for the edge device to validate the deduplication fingerprints of the customer data volume 256 against the blocks of data in the edge cache 210.

At block 314, the traffic management code 150 is notified to validate the stored fingerprints in the map 220B against for the blocks of data in the edge cache 210 that need to be destaged to the customer data volume 256. The data storage engine 250 of the public cloud 105 sends the fingerprint calculator algorithm 222A (which is stored as fingerprint calculator algorithm 222B) and the map 220A (which is stored as the map 220B) to the edge device 202 such that the traffic management code 150 can use fingerprint calculator algorithm 222B to calculate the deduplication fingerprints for all the participating blocks in the edge cache 210, for eventual comparison with the stored fingerprints in the map 220B (e.g., B-tree).

Referring to FIG. 3B, at block 316, in response to receiving the fingerprint calculator algorithm 222B and the map 220B from the public cloud 105, the traffic management code 150 calculates fingerprints for the blocks of data in the cache 210 and maps the calculated fingerprints to the stored fingerprints in the map 220B for comparison. In response to the traffic management code 150 comparing the calculated fingerprints for the blocks in the edge cache 210 to the stored fingerprints for the blocks in the customer data volume 256, the traffic management code 150 uses the map 220B to check for the blocks in the edge cache 210 that are not stored in the customer data volume 256; the traffic management code 150 sends a bitmap of the blocks that are not stored in the customer data volume 256. For the blocks that are found in the map 220B (e.g., dedup B-tree) of the customer data volume 256 based on a match between the calculated fingerprints and the stored fingerprints, the traffic management code 150 updates the tree pointers for defined LBAs and sends a (WRITE) complete message to the data storage engine 250. For the blocks that are not found in the map 220B (e.g., dedup B-tree) of the customer data volume 256 (i.e., there is no match between a calculated fingerprint and any of the stored fingerprints in the map 220B), the traffic management code 150 locates the blocks of data in the local edge cache 210 and sends them over the communication tunnel 280 (i.e., without sending the blocks of data 270 that were found to have matching fingerprints in the map 220B). The traffic management code 150 waits for the completion response and marks I/O complete once the acknowledgement (ACK) is received.

At block 318, in response to receiving the message (e.g., I/O WRITE) from the traffic management code 150, the data storage engine 250 already knows that the these are new fingerprints that were pre-validated by the edge device 202, and accordingly, the data storage engine 250 bypasses the fingerprint calculation on incoming I/O requests of the blocks of data 272. The data storage engine 250 writes the data to the new location in the customer data volume 256, sends the acknowledgement (ACK) to the edge device 202, and marks (WRITE) complete.

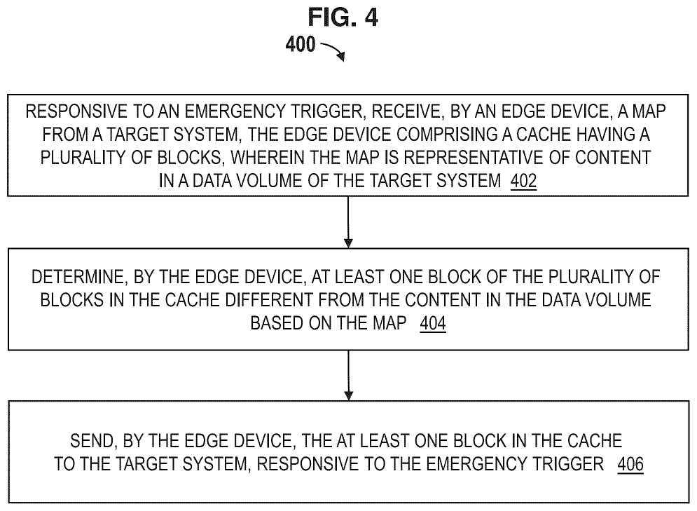

FIG. 4 is a flowchart of a computer-implemented method 400 for providing improved traffic management during an emergency destage of data in an edge device to a target device/system (e.g., public cloud 105) according to one or more embodiments. Reference can be made to any of the figures discussed herein. At block 402, the traffic management code 150 in the edge device 202 is configured to, responsive to an emergency trigger (e.g., from the power module 236), receive a map 220B from a target system (e.g., from the public cloud 105, the edge device 202 including an edge cache 210 having a plurality of blocks or chunks of data, where the map 220B is representative of content in a data volume (e.g., customer data volume 256) of the target system (e.g., public cloud 105). At block 404, the traffic management code 150 in the edge device 202 is configured to determine at least one block (e.g., blocks of data 272) of the plurality of blocks in the edge cache 210 different from the content in the data volume (e.g., customer data volume 256) based on the map 220B. At block 406, the traffic management code 150 in the edge device 202 is configured to send the at least one block (e.g., blocks of data 272) in the edge cache 210 to the target system (e.g., customer data volume 256), responsive to the emergency trigger.

Further, the edge device 202 receives an algorithm (e.g., fingerprint algorithm 222B) associated with the map 220B. The edge device 202 is configured to utilize an algorithm (e.g., fingerprint algorithm 222B) to compare the edge cache 210 to the content in the data volume (e.g., customer data volume 256) based on the map 220B. For example, the edge device 202 uses the fingerprint algorithm 222B to calculate fingerprints for blocks in the edge cache 210 and compares the calculated fingerprints to the corresponding fingerprints stored in the map 220B. The edge device 202 is configured to utilize the algorithm (e.g., fingerprint algorithm 222B) to determine a fingerprint of the at least one block (in the edge cache 210) that is different from predetermined fingerprints of the map 220B.

Additionally, the determining the at least one block of the plurality of blocks in the edge cache 210 is utilized to avoid sending other blocks (e.g., to avoid sending the blocks of data 270) of the plurality of blocks to the target system, responsive to the emergency trigger. At least one updated pointer corresponding to one block of the plurality of blocks is sent to the target system, the at least one updated pointer identifying the content previously stored in the target system for the one block. The sending of the at least one block in the edge cache 210 to the target system (e.g., customer data volume 256) causes the target system to store the at least one block without validating a fingerprint for the at least one block; the emergency trigger occurs responsive to a power failure at the edge device such that the edge device requires backup power from the backup power system 230.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
responsive to an emergency trigger, receiving, by an edge device, a map from a target system, the edge device comprising a cache having a plurality of blocks, wherein the map is representative of content in a data volume of the target system;
determining, by the edge device, at least one block of the plurality of blocks in the cache different from the content in the data volume based on the map; and
sending, by the edge device, the at least one block in the cache to the target system, responsive to the emergency trigger.

2. The computer-implemented method of claim 1, wherein the edge device receives an algorithm associated with the map.

3. The computer-implemented method of claim 1, wherein the edge device is configured to utilize an algorithm to compare the cache to the content in the data volume based on the map.

4. The computer-implemented method of claim 3, wherein the edge device is configured to utilize the algorithm to determine a fingerprint of the at least one block that is different from predetermined fingerprints of the map.

5. The computer-implemented method of claim 1, wherein the determining the at least one block of the plurality of blocks in the cache is utilized to avoid sending other blocks of the plurality of blocks to the target system, responsive to the emergency trigger.

6. The computer-implemented method of claim 1, wherein at least one updated pointer corresponding to one block of the plurality of blocks is sent to the target system, the at least one updated pointer identifying the content previously stored in the target system for the one block.

7. The computer-implemented method of claim 1, wherein:
the sending the at least one block in the cache to the target system causes the target system to store the at least one block without validating a fingerprint for the at least one block; and
the emergency trigger occurs responsive to a power failure at the edge device such that the edge device requires backup power.

8. A system comprising:
a memory having computer readable instructions; and
a computer for executing the computer readable instructions, the computer readable instructions controlling the computer to perform operations comprising:
responsive to an emergency trigger, receiving, by the computer, a map from a target system, the computer comprising a cache having a plurality of blocks, wherein the map is representative of content in a data volume of the target system;
determining, by the computer, at least one block of the plurality of blocks in the cache different from the content in the data volume based on the map; and
sending, by the computer, the at least one block in the cache to the target system, responsive to the emergency trigger.

9. The system of claim 8, wherein the computer receives an algorithm associated with the map.

10. The system of claim 8, wherein the computer is configured to utilize an algorithm to compare the cache to the content in the data volume based on the map.

11. The system of claim 10, wherein the computer is configured to utilize the algorithm to determine a fingerprint of the at least one block that is different from predetermined fingerprints of the map.

12. The system of claim 8, wherein the determining the at least one block of the plurality of blocks in the cache is utilized to avoid sending other blocks of the plurality of blocks to the target system, responsive to the emergency trigger.

13. The system of claim 8, wherein at least one updated pointer corresponding to one block of the plurality of blocks is sent to the target system, the at least one updated pointer identifying the content previously stored in the target system for the one block.

14. The computer-implemented method of claim 8, wherein:
the sending the at least one block in the cache to the target system causes the target system to store the at least one block without validating a fingerprint for the at least one block; and
the emergency trigger occurs responsive to a power failure at the computer such that the computer requires backup power.

15. A computer program product comprising a computer readable storage medium having program instructions embodied therewith, the program instructions executable by a computer to cause the computer to perform operations comprising:
responsive to an emergency trigger, receiving, by the computer, a map from a target system, the computer comprising a cache having a plurality of blocks, wherein the map is representative of content in a data volume of the target system;
determining, by the computer, at least one block of the plurality of blocks in the cache different from the content in the data volume based on the map; and
sending, by the computer, the at least one block in the cache to the target system, responsive to the emergency trigger.

16. The computer program product of claim 15, wherein the computer receives an algorithm associated with the map.

17. The computer program product of claim 15, wherein the computer is configured to utilize an algorithm to compare the cache to the content in the data volume based on the map.

18. The computer program product of claim 17, wherein the computer is configured to utilize the algorithm to determine a fingerprint of the at least one block that is different from predetermined fingerprints of the map.

19. The computer program product of claim 15, wherein the determining the at least one block of the plurality of blocks in the cache is utilized to avoid sending other blocks of the plurality of blocks to the target system, responsive to the emergency trigger.

20. The computer program product of claim 15, wherein at least one updated pointer corresponding to one block of the plurality of blocks is sent to the target system, the at least one updated pointer identifying the content previously stored in the target system for the one block.
